(19) United States
(12) Patent Application Publication
(10) Pub. No.: US 2013/0050223 A1
(43) Pub. Date: Feb. 28, 2013

(54) Method of Fine-Tuning Chinese Characters according to Font Size and Chinese Character Fine-Tuning System thereof

(71) Applicants: Fu-Sheng Wu, Taoyuan County (TW); Yi-Hui Huang, Taipei City (TW)

(72) Inventors: Fu-Sheng Wu, Taoyuan County (TW); Yi-Hui Huang, Taipei City (TW)

(21) Appl. No.: 13/585,817

(22) Filed: Aug. 14, 2012

(30) Foreign Application Priority Data
Aug. 22, 2011 (TW) 100130002

(51) Int. Cl. G09G 5/26

(52) U.S. Cl. 345/472.1

(57) ABSTRACT

Before reducing a font size of a Chinese character, a to-be-adjusted standard radical is determined according to a non-neighboring outline ratio of a standard radical, and a radical serial list is established for the to-be-adjusted standard radical in a font database, for the purpose of consecutively updating the to-be-adjusted standard radical in the future. While the Chinese character is reduced by its font size, a radical serial list corresponding to the to-be-adjusted standard radical is first searched. The to-be-adjusted standard radical is then updated into a transformed radical step-by-step according to the radical serial list. At last, the transformed radical is used for replacing the to-be-adjusted standard radical to generate a transformed character, so as to achieve the effect of fine-tuning the Chinese character having the reduced font size.

### BACKGROUND OF THE INVENTION

1. Field of the Invention

The present invention relates to a method of fine-tuning a Chinese character according to a font size and a Chinese character fine-tuning system thereof, and more particularly, a method of fine-tuning a Chinese character by continuously transforming radicals of the Chinese character and a Chinese character fine-tuning system thereof.

2. Description of the Prior Art

When a conventional computer displays a Chinese character and is required to reduce a displayed font size of the Chinese character, a shrunken Chinese character will always suffer a distortion, for example, dimed strokes on the shrunken Chinese character. For neutralizing such distortions, there are some techniques that change radicals or strokes of radicals for updating a Chinese character.

Conventionally, while processing an outline Chinese character consisting of strokes, each stroke may be assigned with an identity and a plurality of stroke parameters, where the identity and the plurality of stroke parameters may be stored in a font database, and the plurality of stroke parameters may include locations and widths of the strokes in the Chinese character. Therefore, for displaying a Chinese character, the outline Chinese character can be generated and displayed by loading each stroke of the Chinese character from the font database.

While processing an outline Chinese character consisting of radicals, each of the radicals is assigned a radical identity and a plurality of radical parameters, where the radical identity and the plurality of radical parameters are stored in the font database, and the plurality of radical parameters include information of each stroke of the radical (e.g. a location and a width of each the stroke) and a location of the radical in the outline Chinese character. When the radical is scalable, the plurality of radical parameters may further include a size of each radical.

However, when a distortion occurs on a scaled-down Chinese character when the above-mentioned conventional techniques are utilized for handling the distortion, some defects may be introduced so that a user is not satisfied with a display quality of the scaled-down Chinese character. For example, a shrunken Chinese character consisting of radicals may not be displayed well and in an unstable manner since a whole radical structure of the shrunken Chinese character is required to be adjusted and since the size of the shrunken Chinese character may be over-reduced in one operation. As for a Chinese character consisting of strokes, the Chinese character can be fine-tuned by fine-tuning sizes of strokes suffering a distortion, however, a whole structure of the Chinese character is further required to be fine-tuned. On top of that, variations of parameters after each fine-tuning are also required to be recorded, and it will introduce a significant data storage requirement and much time for fine-tuning.

Besides, as for TrueType, which is a conventionally utilized font for English characters, fine-tuning of a font size can be implemented by merely controlling an outline size, however, locations of strokes or radicals are not considered in the fine-tuning so that TrueType fonts cannot be directly utilized for fine-tuning strokes and radicals.

### SUMMARY OF THE INVENTION

The claimed invention discloses a method of fine-tuning a Chinese character according to a font size. The method comprises reducing a font size of a Chinese character in a font database for generating at least one shrunken Chinese character. Whether a non-neighboring outer frame ratio of each standard radical comprised by the at least one shrunken Chinese character is lower than a lower-bound non-neighboring outer frame ratio is a factor for determining at least one to-be-adjusted standard radical. A radical serial list is generated for each of the at least one to-be-adjusted standard radical, wherein each element of the radical serial list is configured to store an available font size range and a radical transformation instruction for each of the at least one to-be-adjusted standard radical. When a font size system reduces a font size for displaying the Chinese character to generate a reduced font size, the font displaying system searches for a radical serial list corresponding to each of the at least one to-be-adjusted standard radical according to the reduced font size and the at least one to-be-adjusted standard radical. The font database is searched for an element in the radial serial list corresponding to the reduced font size to generate a found element, and consecutively fetches and executes radical transformation instructions of elements from a beginning element of the radical serial list to the found element until radical transformation instructions of the found element are executed, for updating each of the at least one to-be-adjusted standard radical to generate an intermediate radical for each of the at least one to-be-adjusted standard radical. The font displaying system replaces each of the at least one standard radical with a corresponding intermediate radical for generating a transformed Chinese character.

The claimed invention further discloses a Chinese character fine-tuning system for find-tuning a Chinese character in response to a font size. The Chinese character fine-tuning system comprises a font database and a font displaying system. The font database is configured to reduce a font size of a Chinese character for generating at least one shrunken Chinese character, configured to determine whether a non-neighboring outer frame ratio of each standard radical comprised by the at least one shrunken Chinese character is lower than a lower-bound non-neighboring outer frame ratio for determining at least one to-be-adjusted standard radical, configured to generate a radical serial list for each of the at least one to-be-adjusted standard radical, configured to search for an element in the radial serial list corresponding to the reduced font size to generate a found element, and configured to consecutively fetch and execute radical transformation instructions of elements from a beginning element of the radical serial list to the found element until radical transformation instructions of the found element are executed for updating each of the at least one to-be-adjusted standard radical to generate an intermediate radical for each of the at least one to-be-adjusted standard radical. The font displaying system is configured to search for a radical serial list in the font database corresponding to each of the at least one to-be-adjusted standard radical according to a reduced font size of the Chinese character and the at least one to-be-adjusted standard radical when the Chinese character is displayed using the reduced font size, and configured to replace each of the at least one standard radical with a corresponding intermediate radical for generating a transformed Chinese character. Each element of the radical serial list is configured to store an available font size range and a radical transformation instruction for each of the at least one to-be-adjusted standard radical.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 illustrate how to determine a shrunken Chinese character according to an embodiment of the present invention.

FIG. 3 schematically illustrates a Chinese character fine-tuning system for fine-tuning a Chinese character corresponding to a font size of the Chinese character according to one embodiment of the present invention.

FIG. 4 schematically illustrates radical serial lists respectively generated for different standard radicals.

FIGS. 5-18 schematically illustrate how to fine-tune a Chinese character under different font sizes using the Chinese fine-tuning system shown in FIG. 3 and the radical serial lists shown in FIG. 4, according to one embodiment of the present invention.

FIG. 19 illustrates a flowchart of the Chinese character fine-tuning method according to one embodiment of the present invention.

### DETAILED DESCRIPTION

In the method of fine-tuning a Chinese character according to a font size in the present invention, some objective factors are first utilized for determining to-be-adjusted Chinese characters, where the objective factors are utilized for indicating whether a shrunken Chinese character fails in its legibility; then radicals of the to-be-adjusted Chinese character that can be transformed continuously are utilized for fine-tuning the Chinese character so that a radial serial list capable of dynamically supporting the continuous transformation of radicals can be generated in advance. Since utilizing the radical serial list for fine-tuning the Chinese character will introduce a significantly-reduced amount of data storage than the conventional means mentioned above, a process of dynamically fine-tuning the Chinese character can be efficiently accelerated.

The method of the present invention primarily includes steps of determining shrunken Chinese character having poor legibility, generating the radical serial list in advance, and dynamically fine-tuning the Chinese character using the radical serial list.

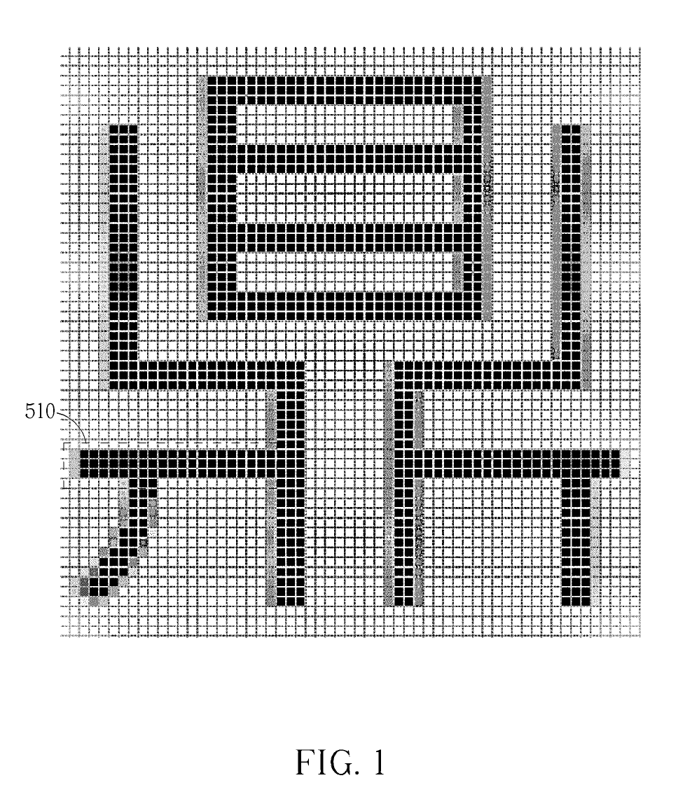

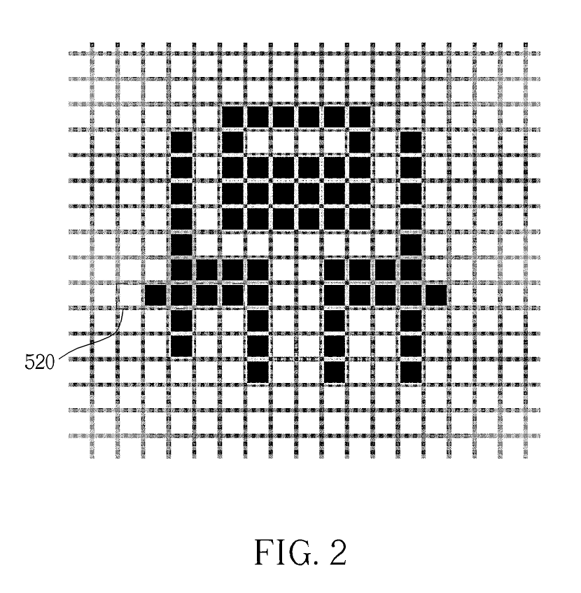

Examples will be given in advance in the following for explaining how to determine a shrunken Chinese character having a poor legibility in some embodiments of the present invention. Please refer to FIG. 1 and FIG. 2, which illustrate how to determine a shrunken Chinese character according to an embodiment of the present invention. In FIG. 1, a Chinese character Din (which is pronounced as ‘din’ in Mandarin) is illustrated, where a stroke 510 of the Chinese character Din is also pointed out by a dotted line. In FIG. 2, a shrunken Chinese character Din is illustrated, where a stroke 520 is also pointed out by a dotted line, and the stroke 520 is generated by shrinking the stroke 510.

An original outline length of the stroke 510, i.e. a length of the dotted line surrounding the stroke 510, is 50 grids; and an effective outline length of the stroke 510 is 42 grids by excluding overlapped portion from other strokes. Therefore, a non-neighboring outline ratio of the stroke 510 is equal to (42/50)*100%=80%. An original outline length of the stroke 520, i.e. a length of the dotted line surrounding the stroke 520, is 16 grids; and an effective outline length of the stroke 520 is 7 grids by excluding overlapped portion. Therefore, a non-neighboring outline ratio of the strobe 520 is equal to (7/16)*100%=43.75%. As can be observed from FIG. 1 and FIG. 2, because of the significant reduction of the non-neighboring outline ratio of the Chinese character Din after being shrunken, the legibility of the Chinese character Din is significantly reduced, and it indicates that the shrunken Chinese character Din shown in FIG. 2 is required to be fine-tuned for regaining its legibility.

In embodiments of the present invention, a font size of a Chinese character is reduced to different smaller font sizes to generate different shrunken Chinese characters, for confirming a non-neighboring outline ratio of standard radicals included by each the shrunken Chinese character. Each standard radical may include at least one stroke. A non-neighboring outline ratio of a standard radical may be derived by calculating an average of non-neighboring outline ratios of all strokes of the standard radical. When at least one non-neighboring outline ratio of at least one standard radical of a shrunken Chinese character is lower than a lower-bound non-neighboring outline ratio, the at least one standard radical is regarded as at least one to-be-adjusted standard radical, and the shrunken Chinese character is regarded as failing its legibility. In one embodiment of the present invention, the lower-bound non-neighboring outline ratio is 50%.

After the at least one to-be-adjusted standard radical included by the shrunken Chinese character is confirmed, at least one radical serial list is established for each of the at least one to-be-adjusted standard radical and is configured to store means of fine-tuning a corresponding to-be-adjusted standard radical under a purpose of improving a legibility of the corresponding to-be-adjusted standard radical, where the at least one radical serial list is then stored in a Chinese character fine-tuning system disclosed in the present invention. The means of fine-tuning the corresponding to-be-adjusted standard radical is represented by at least one data structure respectively corresponding to a different radical size of the corresponding to-be-adjusted standard radical, where each the data structure includes at least one radical transformation instruction.

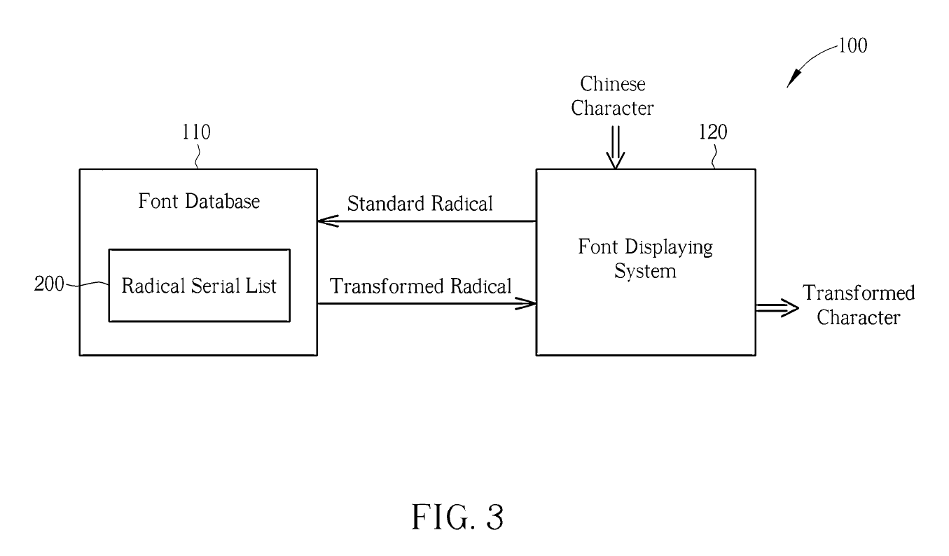

Please refer to FIG. 3, which schematically illustrates a Chinese character fine-tuning system 100 for fine-tuning a Chinese character corresponding to a font size of the Chinese character according to one embodiment of the present invention. The Chinese character fine-tuning system 100 includes a font database 110 and a font displaying system 120.

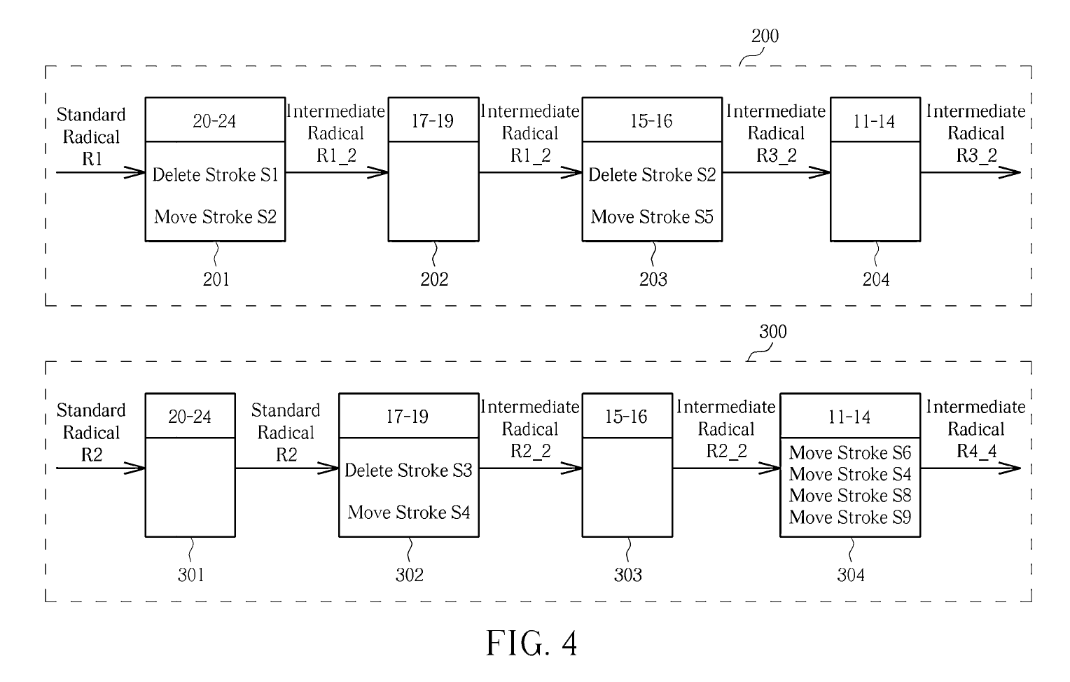

The font database 110 stores a plurality of standard radicals included by a Chinese character and generates a radical serial list for each of the plurality of standard radicals. Please refer to FIG. 4, which schematically illustrates a radical serial list 200 generated for a standard radical R1 and a radical serial list 300 generated for a standard radical R2, where the standard radicals R1 and R2 are stored by the font database 110, and the radical serial lists 200 and 300 are generated by the font database 110. As shown in FIG. 4, the radical serial list 200 includes data structures 201, 202, 203 and 204, each of which stores an available font size range and at least one radical transformation instruction for a same Chinese character. In one embodiment of the present invention, the radical transformation instruction may be a stroke deletion instruction, a stroke moving instruction, or a stroke width setting instruction. Some strokes may be dimmer after their stroke sizes or outline lengths are increased, i.e. when the non-neighboring outline ratio is over-decreased and other strokes in a same Chinese character may be unreadable as a side effect; therefore, with the aid of using the stroke deletion instruction to delete dim strokes, readability of the scaled-up strokes can be improved without the penalty of reducing the readability of other strokes in the same Chinese character.

Besides, radical transformation instructions in a data structure are established for different font sizes of a same Chinese character in the aspect of art design for preventing occurrence of introducing a dim Chinese character or dim strokes. In other words, even if a standard radical is included by two different Chinese characters, two radical serial lists carrying different radical transformation instructions are still required to be established for fulfilling readability of both the Chinese characters under different font sizes.

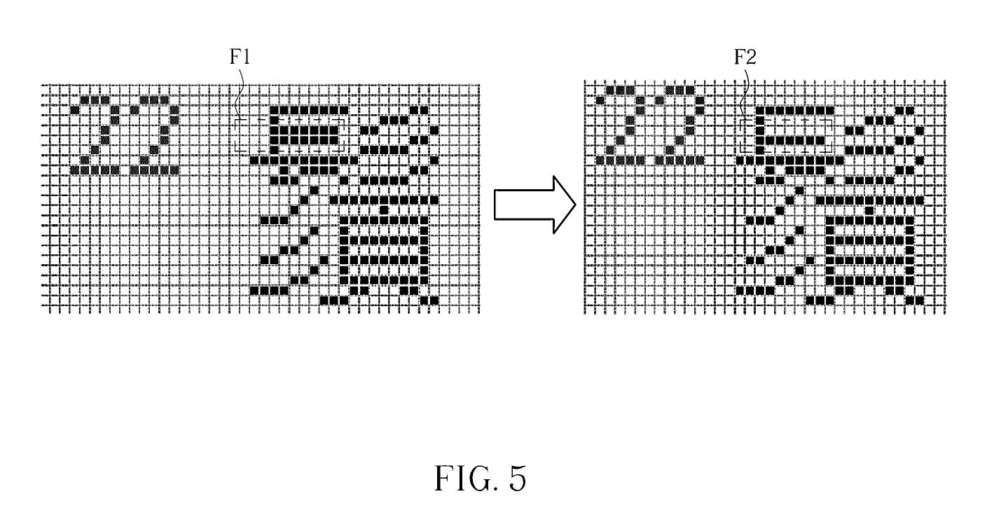

Please refer to FIGS. 5-18, which schematically illustrate how to fine-tune a Chinese character Hsu (pronounced as ‘hsu’) under different font sizes using the Chinese fine-tuning system 100 shown in FIG. 3 and the radical serial lists 200 and 300, according to one embodiment of the present invention. The radical serial list 200 is configured to process a standard radical R1 included by the Chinese character Hsu, the radical serial list 300 is configured to process a standard radical R2 included by the Chinese character Hsu, and both the standard radicals R1 and R2 are assumed to have been determined as to-be-adjusted standard radicals.

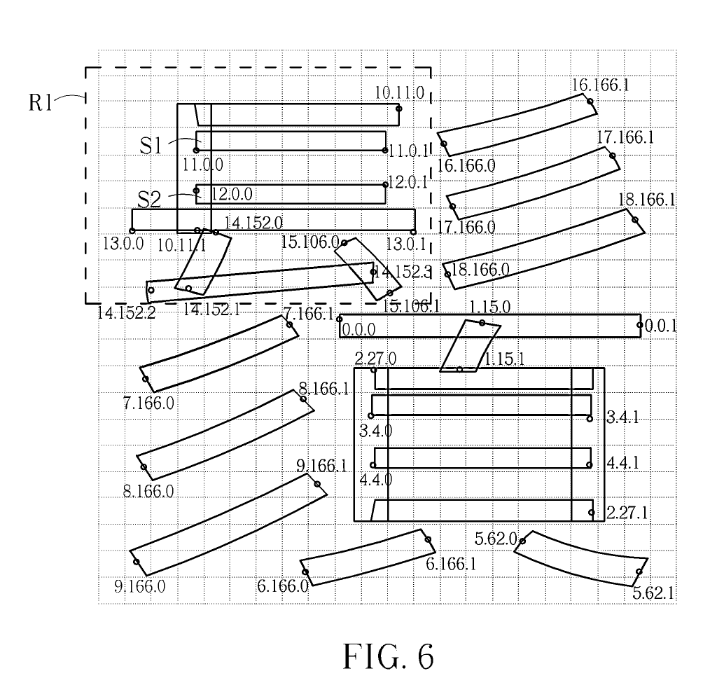

In FIG. 5, when a font size of the Chinese character Hsu is set to be 22, a dim region F1 is formed because two strokes are stuck to each other. Therefore, radical transformation instructions are utilized to neutralize dim strokes in the dim region F1 to form a readable region F2, where the dim region F1 can be determined according to non-neighboring outline ratios of the stuck strokes. FIGS. 6-8 illustrate a bitmap diagram of the Chinese character Hsu in a font size of 16*16, for illustrating how to fine-tune standard radicals of the Chinese character Hsu in detail. In FIGS. 6-8, each stroke is assumed to have at least two characteristic points, each of which is marked by a combination of three numbers, where a first number indicates a stroke order of a stroke located by the characteristic point, a second number indicates an identity code of the stroke, and a third number indicates a characteristic point order of the characteristic point on the stroke. Take a characteristic point marked by a combination (14.152.2) on FIG. 6 as an example, the combination (14.152.2) indicates that a stroke located by the characteristic point is a fourteenth stroke of the Chinese character Hsu, that an identity code of the stroke is 152, and that the characteristic point is a third characteristic point on the stroke (the value 0 indicates a first characteristic point on the stroke). Definitions of the combination are applicable for the whole spec so that the definitions of the combination will not be further reminded in the following descriptions.

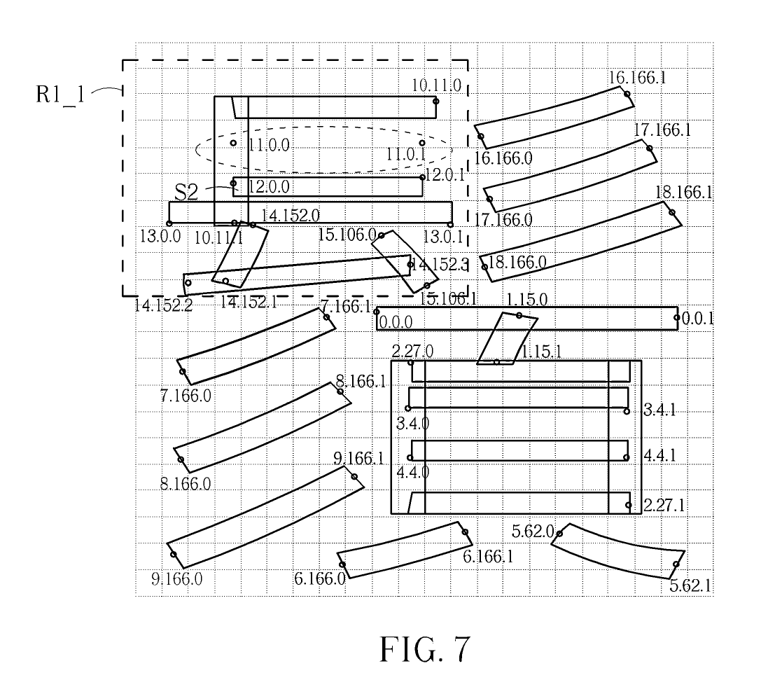

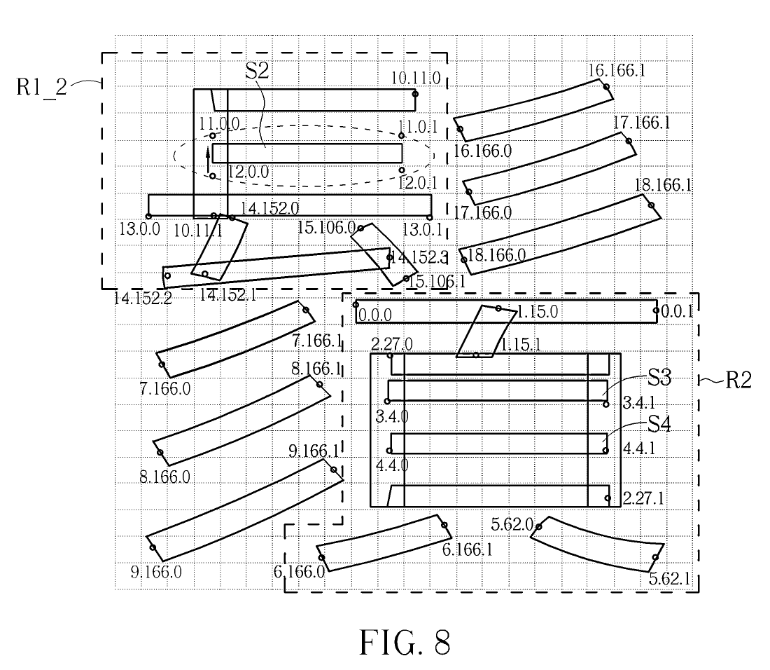

The standard radical R1 shown in FIGS. 6-8, i.e. the standard radical R1 corresponding to the radical serial list 200 shown in FIG. 4, covers both the dim region F1 and the readable region F2 shown in FIG. 5. For neutralizing the dim region F1, two stroke instructions are performed; a first stroke instruction is a stroke deletion instruction for deleting a dim stroke S1 to generate an intermediate radical R1_1, as shown in FIGS. 6-7, and a second stroke instruction is a stroke moving instruction for moving a stroke S2 upward to fitting space left by the deleted stroke S1 and to generate an intermediate radical R1_2, as shown in FIGS. 7-8. The stroke deletion instruction for deleting the stroke S1 and the stroke moving instruction for moving the stroke S2 are stored in the data structure 201 shown in FIG. 4, so that the font database 110 is capable of fetching and performing the stroke instructions from the data structure 201 to neutralize dim strokes in the dim region S1 under a font size ranged from 20-24.

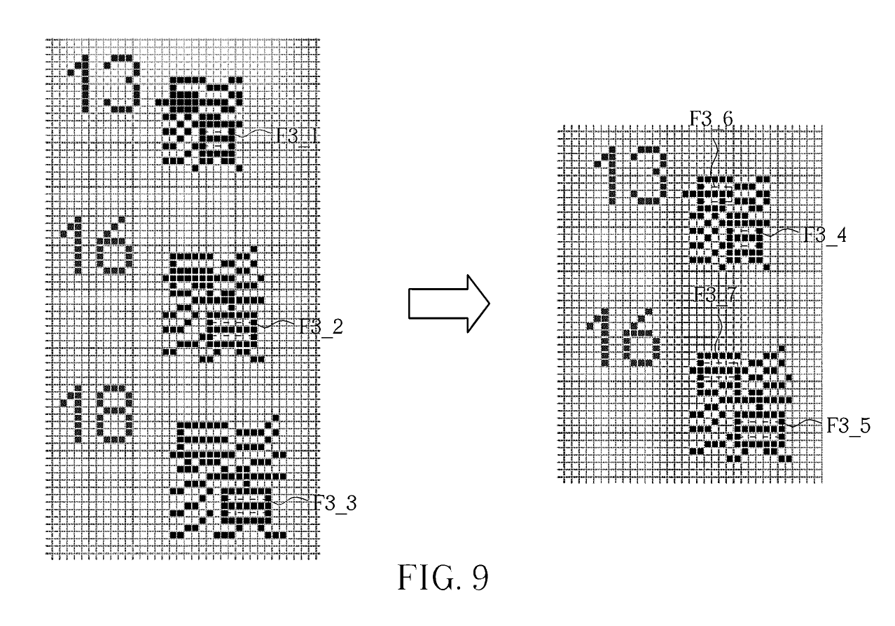

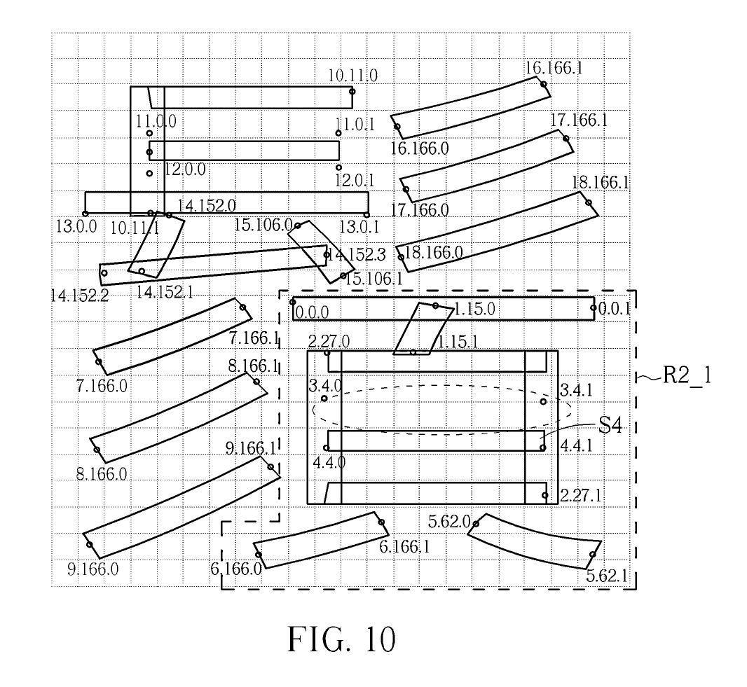

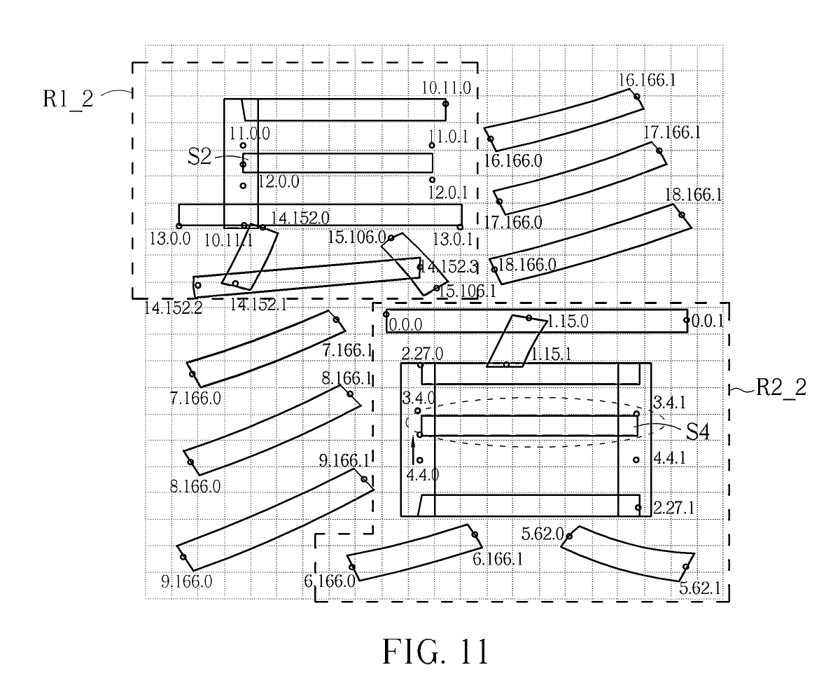

Although a result of fine-tuning in FIGS. 5-8 neutralizes dim strokes in the dim stroke S1 of the Chinese character Hsu under a font size of 22, new dim strokes may occur if the font size is made smaller. Please refer to FIGS. 9-11, which schematically illustrate how to neutralize dim strokes of the Chinese character Hsu shown in FIGS. 5-8 under a font size of 13, 16, or 18 using radical transformation instructions. FIG. 9 is illustrated as a computer-outputted font diagram. FIGS. 10-11 are illustrated as bitmap diagrams of a size of 16*16.

In FIG. 9, there is a dim region F31 under a font size of 13, a dim region F3_2 under a font size of 16, and a dim region F3_3 under a font size of 18, where the dim regions F3_1, F3_2 and F3_3 are corresponding to the standard radical R2 shown in FIG. 8, i.e. the radical serial list 300 corresponding to the standard radical R2. Similarly, the font database 110 fetches and performs radical transformation instructions stored in the data structure 302 of the radical serial list 300 for neutralizing the dim regions F3_1, F3_2 and F3_3. A first radical transformation instruction of the data structure 302 is utilized by the font database 110 to delete a stroke S3 covered by the radical R2 to generate an intermediate radical R2_1, as shown in FIGS. 8-10. A second radical transformation instruction of the data structure 302 is performed by the font database 110 to move the stroke S4 upward for fitting the space left by the deleted stroke S3 and to generate an intermediate radical R2_2, as shown in FIGS. 10-11.

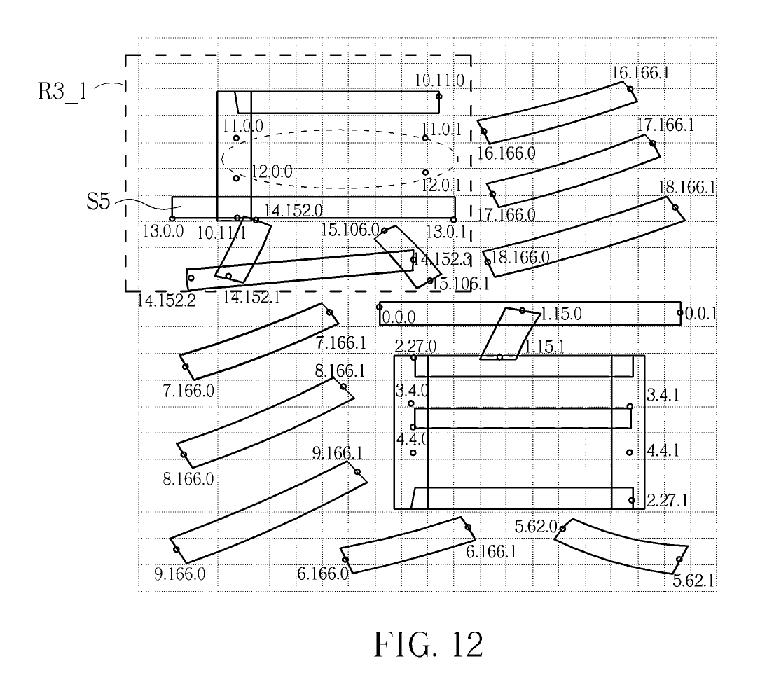

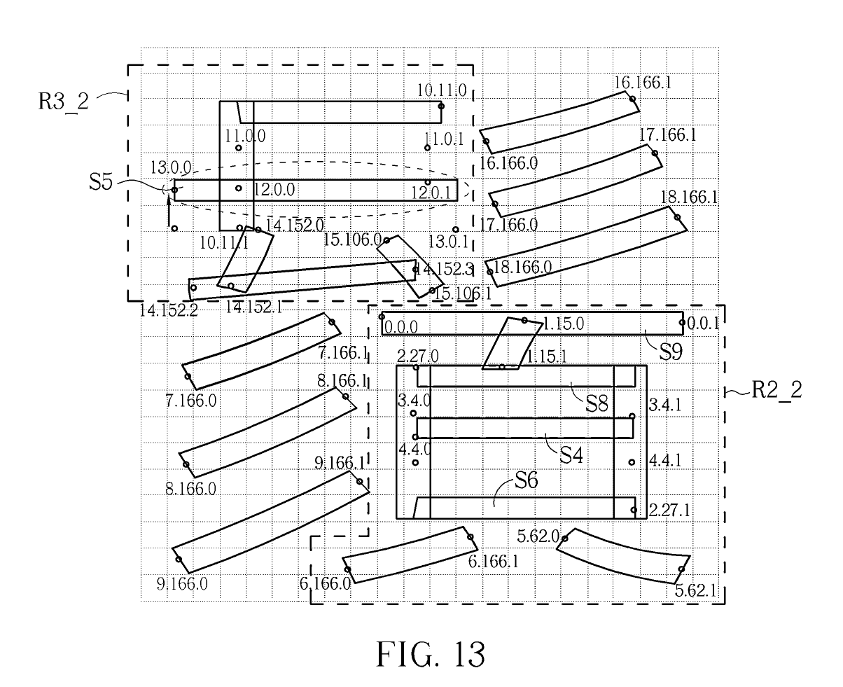

Similarly, as shown in the readable regions F3_4 and F3_5 in FIG. 9, dim strokes of the Chinese character Hsu under a font size between 17 and 19(e.g. 18) have been neutralized after performing radical transformation instructions following FIGS. 10-11. However, there are still dim regions F3_6 and F3_7 as shown in FIG. 9, where both the dim regions F3_6 and F3_7 are corresponding to the intermediate radical R1_2. Please refer to FIGS. 12-13, which schematically illustrate how to neutralize dim strokes in the dim regions F3_6 and F3_7 by performing radical transformation instructions on the Chinese character Hsu under a font size being decreased to between 13 and 16.

For neutralizing the dim regions F3_6 and F3_7 shown in FIG. 9, the font database 110 is configured to fetch and perform radical transformation instructions stored in the data structure 203 of the radical serial list 200. A first radical transformation instruction stored in the data structure 203 is performed for deleting a stroke S2 in the intermediate radical R1_2 for generating an intermediate radical R3_1, as shown in FIGS. 11-12. A second radical transformation instruction stored in the data structure 203 is performed for moving the stroke S5 upward for fitting the space left by deleting the stroke S2 to generate an intermediate radical R3_2, as shown in FIGS. 12-13. Therefore, dim strokes in the dim regions F3_6 and F3_7 shown in FIG. 9 are neutralized.

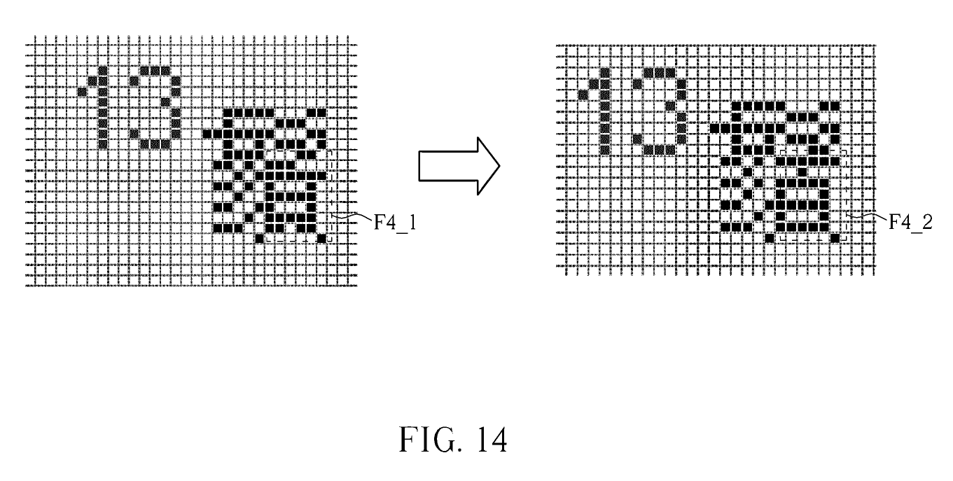

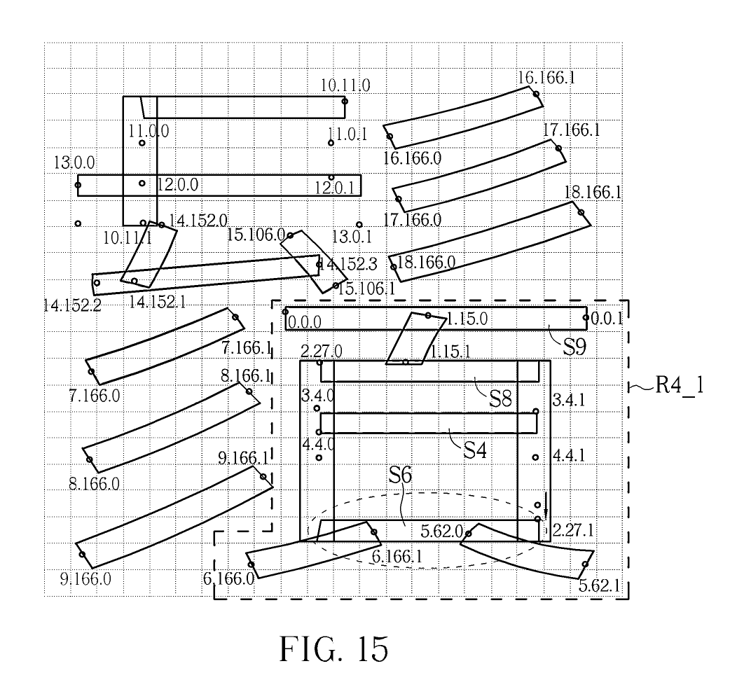

At this time, dim strokes of the Chinese character Hsu of a font size larger than or equal to 15 have been neutralized, however, dim strokes of said Chinese character Hsu of a font size smaller than 15 are still required to be neutralized following steps disclosed in the present invention. Please refer to FIGS. 14-18, which illustrate how to neutralize dim strokes in the Chinese character Hsu of a font size 13 by performing radical transformation instructions according to one embodiment of the present invention, where FIG. 14 is a computer-outputted font diagram, and FIGS. 15-18 are bitmap diagrams of a size 16*16.

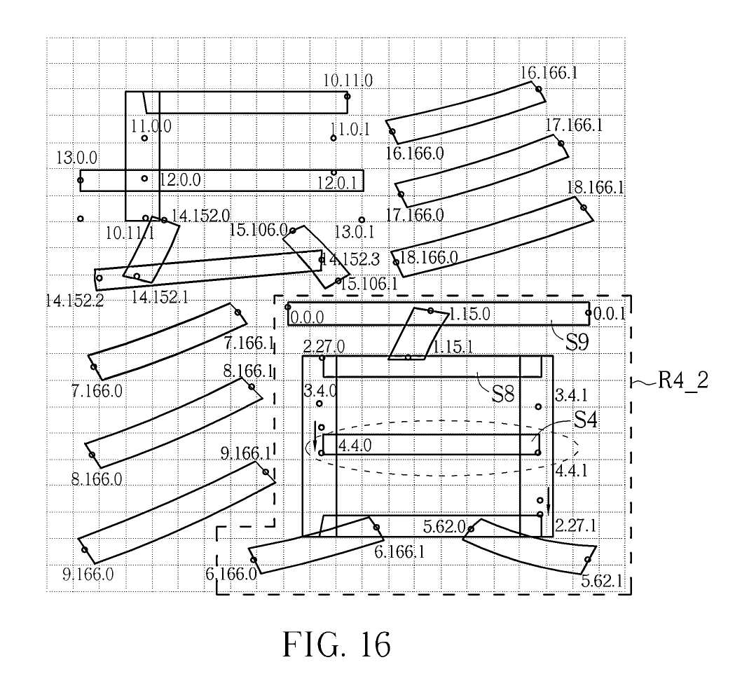

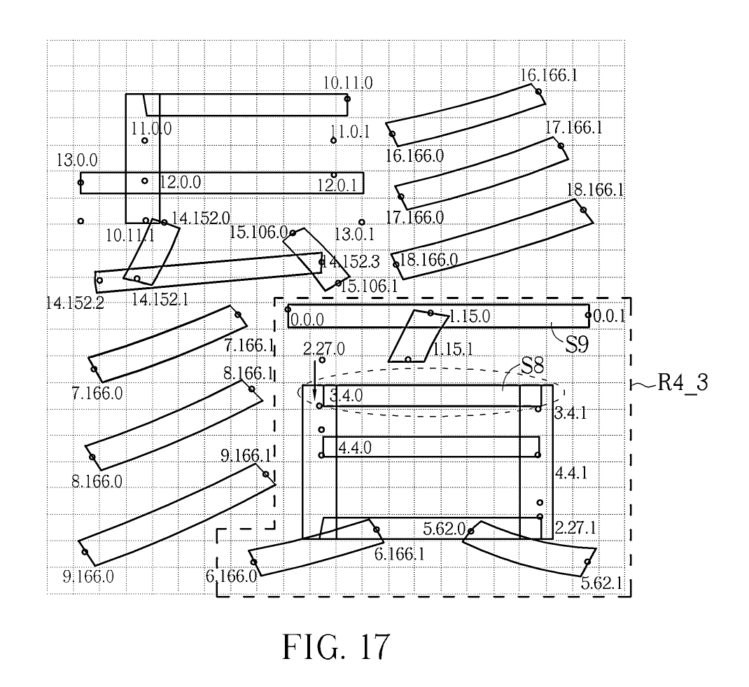

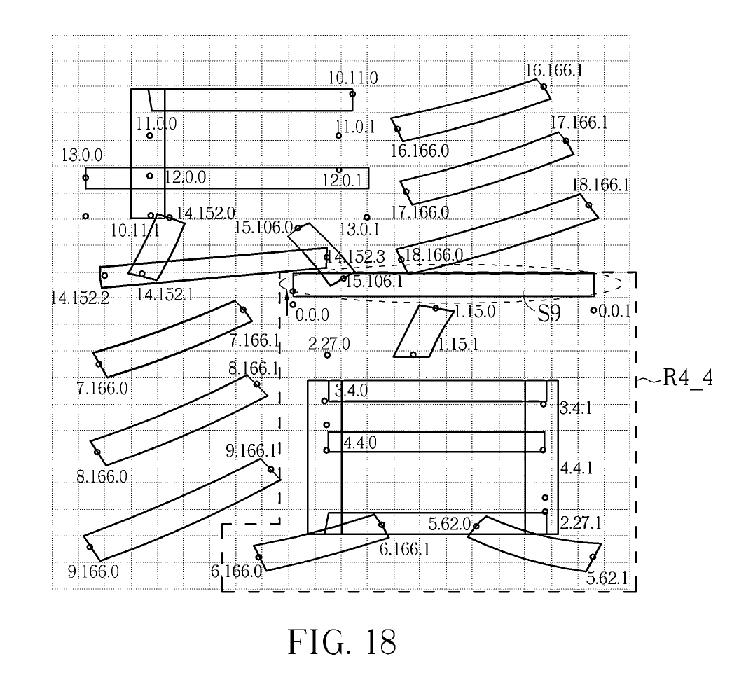

In FIG. 14, the Chinese character Hsu of a font size 13 has dim strokes in a dim region F4_1, which is corresponding to the intermediate radical R2_2. Similarly, the font database 110 is configured to fetch and perform radical transformation instructions stored in the data structure 304 of the radical serial list 300 for neutralizing the dim strokes. There are four radical transformation instructions stored in the data structure 304. A first radical transformation instruction of the data structure 304 is performed for moving a stroke S6 downward to generate an intermediate radical R4_1, as shown in FIG. 13 and FIG. 15. A second radical transformation instruction of the data structure 304 is performed for moving a stroke S4 downward to generate an intermediate radical R4_2, as shown in FIGS. 15-16. A third radical transformation instruction of the data structure 304 is performed for moving a stroke S8 downward to generate an intermediate radical R4_3, as shown in FIGS. 16-17. A fourth radical transformation instruction of the data structure 304 is performed for moving a stroke S9 upward to generate an intermediate radical R4_4, as shown in FIGS. 17-18.

Similarly, after performing radical transformation instructions stored in the data structure 304 as shown in FIGS. 15-18, the Chinese character Hsu of a font size ranged from 11 to 14 has been relieved of dim strokes, as shown in the region F4_2 of FIG. 14.

Last, the font displaying system 120 is configured to replace the standard radical R1 with the intermediate radical R3_2 and configured to replace the standard radical R2 with the intermediate radical R4_4, for the purpose of displaying the Chinese character Hsu free from dim strokes.

Note that in the radical serial lists 200 and 300 shown in FIG. 4, there is no radical transformation instruction stored in the data structures 202, 204, 301 and 303 since no dim stroke occurs under their corresponding font sizes.

In one embodiment of the present invention, before a user of the Chinese character fine-tuning system 100 inputs the Chinese character Hsu, the radical serial lists 200 and 300 have been established and stored in the font database 110 following the radical transformation instructions presented in FIGS. 5-18 in advance. Therefore, when the user inputs the Chinese character Hsu and orders the font displaying system 120 to reduce a font size for displaying the Chinese character Hsu, according to the radical fine-tuning method of the present invention, the font database 110 is configured to find both the radical serial lists 200 and 300 in advance and configured to consecutively fetch and perform radical transformation instructions in the data structures 201, 202, 203 and 204 or in the data structures 301, 302, 303 and 304, for the purpose of displaying the Chinese character Hsu without dim strokes.

As can be observed from descriptions related to FIGS. 4-18, it can be shown that a procedure of fine-tuning the standard radical R1 to generate a transformed radical R3_2, i.e. the intermediate radical R3_2 is consecutive, so is the procedure of fine-tuning the standard radical R2 to generate a transformed radical R4_4, i.e. the intermediate radical R4_4. Based on the fact that how to fine-tune the standard radicals has been established in the radical serial lists and stored in the font database 110, the defect of reducing the legibility of a displayed Chinese character in the prior art can be neutralized when a font size of the displayed Chinese character is decreased to different smaller sizes. Besides, since the data structures utilized in the present invention are established corresponding to radicals, a required data processing amount is significantly small in comparison to the prior art, in which strokes are fine-tuned simultaneously and a large amount of data processing amount is introduced because of the simultaneously-fine-tuned strokes.

Note that in other embodiments of the present invention, a number of types of the radical transformation instructions included by a single data structure are not limited to as shown in FIG. 4. For example, a radical transformation instruction utilized in the present invention may also be a stroke width setting instruction. Embodiments formed by changing the number and the types of radical transformation instructions in a single data structure with respect to as shown in FIG. 4 should also be regarded as embodiments of the present invention.

Note that in other embodiments of the present invention, a number of to-be-adjusted standard radicals in a single Chinese character is not limited to as shown in FIG. 4, i.e. two to-be-adjusted-radicals R1 and R2. In other words, the number of to-be-adjusted standard radicals should be determined according to occurrence of dim strokes under different font sizes of a Chinese character. Therefore, embodiments formed by changing the number of to-be-adjusted standard radicals of a single Chinese character should also be regarded as embodiments of the present invention.

In some embodiments of the present invention, the database 110 may be configured to store standard radicals using an outline format or a single-line format, no matter whether the standard radicals are required to be fine-tuned or not. Color levels of the intermediate radicals/transformed radicals may be displayed in a single color, grey levels, or multiple colors.

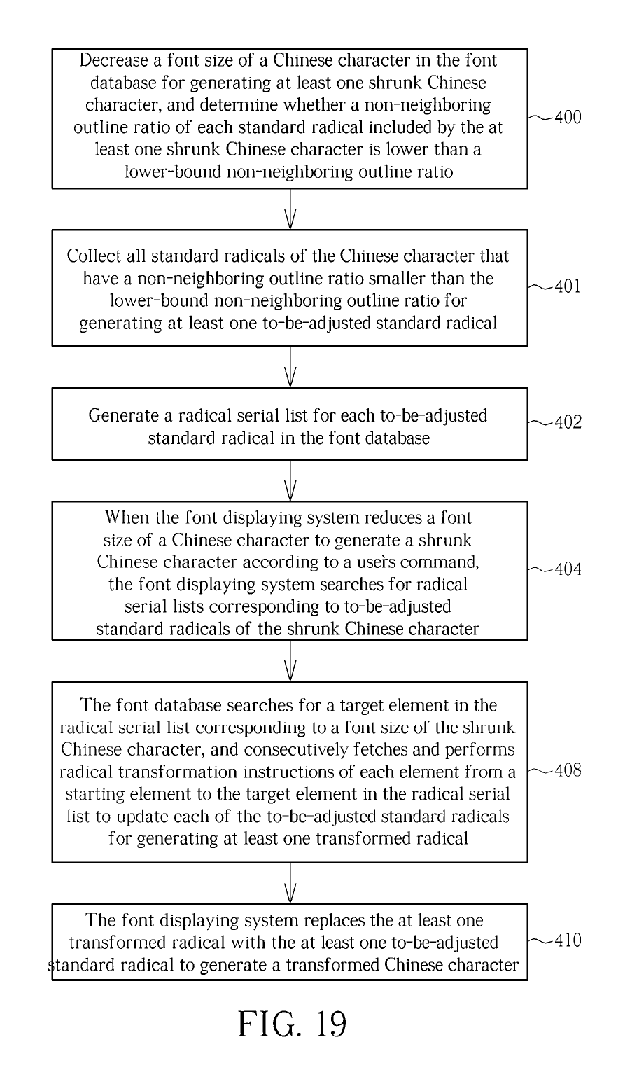

Please refer to FIG. 19, which illustrates a flowchart of the Chinese character fine-tuning method according to one embodiment of the present invention. As shown in FIG. 19, the Chinese character fine-tuning method includes steps as the following:

Step 400: Decrease a font size of a Chinese character in the font database 110 for generating at least one shrunken Chinese character, and determine whether a non-neighboring outline ratio of each standard radical included by the at least one shrunken Chinese character is lower than a lower-bound non-neighboring outline ratio.

Step 401: Collect all standard radicals of the Chinese character that have a non-neighboring outline ratio smaller than the lower-bound non-neighboring outline ratio to generate at least one to-be-adjusted standard radical.

Step 402: Generate a radical serial list for each to-be-adjusted standard radical in the font database 110, where each element of the radical serial list stores an available font size range and at least one radical transformation instruction.

Step 404: When the font displaying system 120 reduces a font size of a Chinese character to generate a shrunken Chinese character according to a user's command, the font displaying system 120 searches for radical serial lists corresponding to to-be-adjusted standard radicals of the shrunken Chinese character.

Step 408: The font database 110 searches for a target element in the radical serial list corresponding to a font size of the shrunken Chinese character, and consecutively fetches and performs radical transformation instructions of each element from a starting element to the target element in the radical serial list to update each of the to-be-adjusted standard radicals for generate at least one transformed radical.

Step 410: The font displaying system 102 replaces the at least one transformed radical with the at least one to-be-adjusted standard radical to generate a transformed Chinese character.

The purpose of Step 400 and Step 401 is to confirm whether a standard radical becomes a dim radical after shrinking the Chinese character with different font sizes according to whether the non-neighboring outline ratio of the standard radical becomes lower than the lower-bound non-neighboring outline ratio, for determining the at least one to-be-adjusted standard radical in the Chinese character.

Then in Step 402, the Chinese character fine-tuning system 100 establishes a radical serial list for each the to-be-adjusted standard radical. For example, the radical serial lists 200 and 300 are established in FIG. 4 in correspondence with how to-be-adjusted standard radicals shown in FIGS. 5-18 are adjusted. Preparations for fine-tuning the Chinese character are completed herein.

Step 404, Step 408 and Step 410 indicate how the Chinese character fine-tuning system 100 works when the font size of the Chinese character is adjusted by a user of the fine-tuning system 100. The font displaying system 120 is configured to search for a corresponding radical serial list (e.g. the radical serial lists 200 and 300) in the font database 110 for each to-be-adjusted standard radical of the shrunken Chinese character of different font sizes, for ensuring a legibility (i.e. readability) of the shrunken Chinese character. How the Chinese character fine-tuning system 100 works in Step 404, Step 408 and Step 410 correspond to how radical transformation instructions stored in the radical serial lists 200 and 300 are fetched and performed.

Note that the transformed character mentioned in Step 410 is a result of fine-tuning the shrunken Chinese character. Embodiments formed by reasonable combinations and permutations of or by adding limitations mentioned above to the steps shown in FIG. 19 should also be regarded as embodiments of the present invention.

In summary, the present invention discloses a Chinese character fine-tuning method/system in response to different font sizes of a Chinese character. In the disclosed Chinese character fine-tuning method/system, a to-be-adjusted standard radical of a shrunken Chinese character is determined according to its non-neighboring outline ratio in advance, and a radical serial list is established for the to-be-adjusted standard radical for preparations, where each element (i.e. data structure) of the radical serial list includes an available font size range and at least one radical transformation instructions that can be consecutively performed. When the user adjusts the font size of the Chinese character, a to-be-adjusted standard radical can be gradually updated by consecutively performing radical transformation instructions in data structures of corresponding radial serial lists to generate required transformed characters. A primary advantage of the present invention lies in gradually updating a Chinese character with a significantly smaller data processing amount in comparison to the prior art for neutralizing dim strokes/radicals in shrunken Chinese characters. With the aid of the small data processing amount introduced in the present invention, a faster Chinese character updating/transformation speed can be fulfilled by the Chinese character fine-tuning method/system of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of fine-tuning a Chinese character according to a font size, comprising:
reducing a font size of a Chinese character in a font database for generating at least one shrunken Chinese character;
determining whether a non-neighboring outer frame ratio of each standard radical comprised by the at least one shrunken Chinese character is lower than a lower-bound non-neighboring outer frame ratio for determining at least one to-be-adjusted standard radical;
generating a radical serial list for each of the at least one to-be-adjusted standard radical, wherein each element of the radical serial list is configured to store an available font size range and a radical transformation instruction for each of the at least one to-be-adjusted standard radical;
when a font size system reduces a font size for displaying the Chinese character to generate a reduced font size, the font displaying system searching for a radical serial list corresponding to each of the at least one to-be-adjusted standard radical according to the reduced font size and the at least one to-be-adjusted standard radical;
searching the font database for an element in the radial serial list corresponding to the reduced font size to generate a found element, and consecutively fetching and executing radical transformation instructions of elements from a beginning element of the radical serial list to the found element until radical transformation instructions of the found element are executed, for updating each of the at least one to-be-adjusted standard radical to generate an intermediate radical for each of the at least one to-be-adjusted standard radical; and
the font displaying system replacing each of the at least one standard radical with a corresponding intermediate radical for generating a transformed Chinese character.

2. The method of claim 1 wherein the radical transformation instruction comprises a stroke deletion instruction, a stroke moving instruction, and/or a stroke width setting instruction.

3. The method of claim 1 wherein the font database stores each the standard radical using an outer frame or lines.

4. The method of claim 1 wherein colors of the transformed Chinese character comprises a single color, gray levels, or multiple colors.

5. The method of claim 1 wherein determining whether the non-neighboring outer frame ratio of each the standard radical comprised by the at least one shrunken Chinese character is lower than the lower-bound non-neighboring outer frame ratio for determining the at least one to-be-adjusted standard radical comprises:
determining a standard radical to be a to-be-adjusted standard radical when a non-neighboring outer frame ratio of the standard radical is lower than the lower-bound non-neighboring outer frame ratio.

6. The method of claim 5 wherein the lower-bound non-neighboring outer frame ratio is 50 percent.

7. A Chinese character fine-tuning system for find-tuning a Chinese character in response to a font size, comprising:
a font database configured to reduce a font size of a Chinese character for generating at least one shrunken Chinese character, configured to determine whether a non-neighboring outer frame ratio of each standard radical comprised by the at least one shrunken Chinese character is lower than a lower-bound non-neighboring outer frame ratio for determining at least one to-be-adjusted standard radical, configured to generate a radical serial list for each of the at least one to-be-adjusted standard radical, configured to search for an element in the radial serial list corresponding to the reduced font size to generate a found element, and configured to consecutively fetch and execute radical transformation instructions of elements from a beginning element of the radical serial list to the found element until radical transformation instructions of the found element are executed for updating each of the at least one to-be-adjusted standard radical to generate an intermediate radical for each of the at least one to-be-adjusted standard radical; and
a font displaying system configured to search for a radical serial list in the font database corresponding to each of the at least one to-be-adjusted standard radical according to a reduced font size of the Chinese character and the at least one to-be-adjusted standard radical when the Chinese character is displayed using the reduced font size, and configured to replace each of the at least one standard radical with a corresponding intermediate radical for generating a transformed Chinese character;
wherein each element of the radical serial list is configured to store an available font size range and a radical transformation instruction for each of the at least one to-be-adjusted standard radical.

8. The Chinese character fine-tuning system of claim 7 wherein the radical transformation instruction comprises a stroke deletion instruction, a stroke moving instruction, and/or a stroke width setting instruction.

9. The Chinese character fine-tuning system of claim 7 wherein the font database is configured to store each the standard radical using an outer frame or lines.

10. The Chinese character fine-tuning system of claim 7 wherein colors of the transformed Chinese character comprises a single color, gray levels, or multiple colors.

11. The Chinese character fine-tuning system of claim 7 wherein the font database is configured to determine a standard radical to be a to-be-adjusted standard radical when the font database determines that a non-neighboring outer frame ratio of the standard radical is lower than the lower-bound non-neighboring outer frame ratio.

12. The Chinese character fine-tuning system of claim 11 wherein the lower-bound non-neighboring outer frame ratio is 50 percents.
